(19) United States
(12) Patent Application Publication
(10) Pub. No.: US 2006/0135372 A1
(43) Pub. Date: Jun. 22, 2006

(54) Controlled degradation of filtercakes and other downhole compositions

(75) Inventors: Mohammad Hossaini, Houston, TX (US); Jeffrey McKennis, The Woodlands, TX (US); Tom Carter, Houston, TX (US)

Correspondence Address: D'AMBROSIO & ASSOCIATES, P.L.L.C., 10260 WESTHEIMER, SUITE 465, HOUSTON, TX, 77042, US

(73) Assignee: Tetra Technologies, Inc.

(21) Appl. No.: 11/303,109

(22) Filed: Dec. 16, 2005

Related U.S. Application Data
(60) Provisional application No. 60/637,827, filed on Dec. 21, 2004.

(51) Int. Cl. E21B 43/00; C09K 8/00

(52) U.S. Cl. 507/200

(57) ABSTRACT

A method for the controlled de-functionalization of downhole polymers comprising contacting downhole, water-dispersible, polymeric material with a dehydrating agent until the water-dispersible polymeric material is sufficiently degraded to be removed. The water-dispersible polymeric material can be found in the downhole formation of a filtercake on production walls, other downhole polysaccharide materials and in fluid loss pills. The contact between the dehydrating agent and the polymeric material is prolonged until the water-dispersible, polymeric material is sufficiently degraded to allow the degraded material to be removed by flushing the drilling fluid. The dehydrating agent is selected from concentrated inorganic salt solutions, concentrated organic salt solutions, acid anhydrides, esters, alcohols, ethers, ketones, aldehydes, amides, organic acids and mixtures thereof.

### CROSS REFERENCES TO RELATED CASES

This is a continuation of U.S. Provisional Patent Application, Ser. No. 60/276,172 filed Dec. 21, 2004, now abandoned.

### FIELD OF THE INVENTION

The present invention relates to a method for the controlled degradation of filtercakes and other downhole compositions. In one aspect, the present invention relates to a method of degrading the functionality of a water-dispersible polymer, such as used in the formation of filtercakes, by contacting the polymer with a dehydrating agent.

### BACKGROUND

During the drilling of oil and gas wells, care must be taken to prevent the loss of formation fluids prior to the production stage of operations. Filtercakes are tough, almost water insoluble coatings that reduce the permeability of formation walls. Low-permeablilty filtercakes are used to seal the walls of an oil and gas formation that are exposed by the drilling process. The layer of filtercake limits losses of drilling fluid from the wellbore and protects the natural formation from any possible damage caused by drillling fluids permeating into the pores within the formation walls. A filtercake is created by the precipitation of solids in the drilling fluid onto the walls of the formation rock, thereby sealing the pores. However, because the filtercake does not permanently plug the pores, it may be removed at a later time when production is desired. When drilling is complete, these filtecakes must be removed from the hydrocarbon-bearing formation so that the formation wall is restored to its natural permeability to allow for hydrocarbon production or cementing.

For a filtercake to form, the drilling fluid must contain some particles of a size only slightly smaller than the pore openings of the formation. These particles are known as bridging particles and are trapped in surface pores, thereby forming a bridge over the formation pores. Soluble solids are used within the filtercake as a bridging agent. Examples of these soluble solids include salt solids in a salt saturated solution when salt solids are chosen as well as finely ground calcium carbonate. The solids are purposely added to the drilling, workover, or completion fluids to form a filtercake that can later be partially dissolved by either aqueous or acidic flushes of the wellbore.

Filtercake building fluids can also contain polymers for suspension of solids within the filtercake and for reducing liquid loss through the filtercake by encapsulating the bridging particles. These can be either natural or synthetic polymers. The polymers may include a single polymer, such as xanthan, selected for its rheological properties combined with a second polymer, a starch for example, selected for the reduction of fluid loss in the wellbore.

At completion of the drilling or other well servicing, the filtercake must be removed to allow production in the formation or the bonding of cement to the formation at the completion stage. Removal of the deposited filtercake should be as complete as possible in order to recover maximum permeability within the formation and thus maximum oil and gas production. Previous methods for removal of the filtercake from a wellbore utilized various types of solutions to dissolve the filtercake. Two commonly known methods include using an acid compound to dissolve the carbonate bridging agents in the filtercake, or using an oxidizing substance to decompose the polysaccharide polymer in the filtercake, thus breaking down the filtercake.

An acid removal solution for the dissolution of a filtercake is described in Hollenbeck et al., U.S. Pat. No. 4,809,783. Here the removal solution is comprised of fluoride ions, controlling the pH of the solution. The fluoride ions holding the pH of the removal solution between 2 and 4, the acid range. In some embodiments, an oxidizer and boric acid are added to the solution.

Another acid compound for filtercake removal is found in Mondshine et al., U.S. Pat. No. 5,238,065, which discloses a two step process and composition for removal of polymer-containing filtercakes from wellbores. First, the filtercake is contacted with a soak solution comprising an aqueous brine, a peroxide and an acidic substance providing a pH from 1 to about 8, for a period of time sufficient to decompose the polysaccharide fibers of the filtercake. The mass created by this process is then contacted with a wash solution in which the bridging particles are soluble to remove the remaining filtercake solids.

Lee, U.S. Patent App. No. 0040055747, discloses an acidic filtercake removal where a polymerized alpha-hydroxycarboxylic acid coated proppant, such as a sized industrial sand. The acid by-product generated from the hydration of polyglycolic-acid-coated sand can breakdown acid-soluble and acid-breakable components embedded in the filtercake.

Yet another acid filtercake removal is found in Dobson et al, U.S. Pat. No. 5,783,527, where a well fluid which deposits a filtercake is disclosed. The fluid is comprised of a peroxide. The filtercake is also removable by contacting it with an acidic solution to activate the peroxide in the filtercake decomposing the polymers in the filtercake.

An oxidizing method for removing filtercake is found in Murphey et al., U.S. Pat. No. 6,143,698. The '698 patent discloses a method for removing filtercake by contacting the filtercake with a brine solution containing an oxidizer, specifically bromine or bromate generating agents, to degrade the polymers within the filtercake. The brine contains bromide salts and an oxidant capable of delayed oxidation of the bromide to bromine under downhole conditions.

Todd, U.S. patent application Ser. No. 09/756,961, also uses an oxidizing method that includes a fluid for depositing a filtercake. A bridging agent comprises a synthesized inorganic compound, which is dissolvable in an aqueous solution. The inorganic bridging agent is a bonded ceramic compound. The inorganic bridging agent is dissolvable in an aqueous solution. The aqueous solution used to dissolve the bridging agent contains a mild organic acid, a hydrolysable ester, an ammonium salt, a chelating agent or a mixture of ammonium salt and a chelating agent. The bridging agent may contain an oxidizer.

Dobson et. al., U.S. Pat. No. 5,607,905, disclose a process for removal of filtercake by depositing a peroxide within the filtercake. The filtercake is contacted with an acidic solution to activate the peroxide and dissolve the polymer.

An additional method of filtercake removal can be found in Weaver et al., U.S. Pat. No. 5,501,276. Weaver '276 discloses a method and composition for removal of filtercake from the walls of wellbores by using an aqueous sugar solution. The solution is comprised of water and sugar where the sugar is selected from a group consisting of monosaccharide sugars, disaccharide sugars, tri-saccharide sugars and mixtures thereof. Contact between the filtercake and this solution for an extended period of time causes disintegration of the filtercake. The fluid composition may also include a surface active agent for promoting the penetration of the drilling fluid and filtercake by the removal composition. The surface active agents are a blend of non-ionic ethoxylated alcohols or a mixture of aromatic sulfonates.

These existing methods require either a strong acid to chemically degrade the carbonate bridging agent in the filtercake or an oxidizing agent to chemically decompose the polymeric portion of the filtercake and chemically break apart the polymeric chains. Strong acids can promote corrosion in the well and lead to a non-uniform filtercake removal because of the rapid reaction rate with the carbonate bridging agent. A non-uniform removal tends to result in limited cake removal across the production interval. The remaining filtercake will restrict flow from the formation and limit oil and gas production from the well.

The use of oxidizing agents to degrade the polymeric portions of the cake also has limitations. Oxidizing agents can also promote corrosion.

Additionally, the effectiveness of the oxidizing agent is limited to lower density fluids. This is a limitation because high density fluids are more effective in preventing the settlement of cuttings in the well bore. Oxidizing agents also add new health, safety, and environmental issues to the project.

As a consequence of the limitations of the existing methods for removing a filtercake from the wellbore, there is a need for a method of removing filtercake that is safe, removes filtercake uniformly throughout the wellbore, does not promote corrosion and minimizes fresh water content from flowing into the formation.

### SUMMARY

In the method of this invention, a filtercake is removed from a subterranean borehole by degrading the functionality of a downhole, water dispersible, polymeric material in the filtercake. The degradation is accomplished by contacting the filtercake or other downhole composition with a dehydrating agent. The removal of water molecules from the water dispersible polymeric structure physically changes the functionality and performance of the filtercake polymers. The removal of water molecules renders the polymers non-functional and changes the physical state to discrete particulates which results in the filtercake breaking apart. The particulates can then be washed away. The use of a dehydrating agent has several advantages over previously existing methods. First, this method avoids the use of either strong acids or oxidizing agents to degrade the filtercake. It is an important improvement since these reagents promote corrosion of metals such as the metals used in casings within the wellbore. Unlike prior methods using strong acids or oxidizing agents, the method of the present invention allows a more controlled removal of the filtercake. The controlled defunctionalization of downhole polymers allows the filtercake to be removed at a slower and more uniform pace thereby avoiding spot breakthroughs of the filtercake lining the walls which results in premature spurts of formation fluid. Additionally, many formations comprise high quantities of clay. Clay swells when contacted with large volumes of water. The method of this invention minimizes the exposure of fresh water sensitive production zones, such as high clay formations, to large volumes of fresh water. Finally, economics often plays the deciding role in the choice of downhole materials. Materials, such as brine that can be recycled, are preferred. The method of this invention facilitates the reclamation of contaminated downhole fluids. Rendering the water-dispersible polymers non-functional leaves the polymers as discrete particulate solids that are more easily separated from the brines than dissolved polymers.

In general, one preferred method for the controlled rendering of downhole polymers non-functional comprises contacting the downhole material with a dehydrating agent. The contact is prolonged until the water-dispersible, polymeric material is sufficiently degraded so as to be non-functional, typically by reducing the polymer to a discrete particulate form. In this way, the degraded material can be removed. Preferably, the water-dispersible, polymeric material can comprise fluid loss pills, or filtercakes. Most often, the filtercake is formed from natural water dispersible polymers, synthetic natural polymers or synthetic water dispersible polymers. Natural water dispersible polymers typically comprising polysaccharides. Included but not limited to this group of polysaccharides are xanthan, hydroxy celluloses, guar gum, and welan gum. Synthetic natural polymers or semi-synthetic polymers are chemically modified natural polymers such as cellulose ethers and various kinds of modified starches including ethers and acetates. Synthetic polymers include acrylic polymers, for example, polyacrylamides and polyacrylates. see Lewis, Richard J., Hawley's Condensed Chemical Dictionary, thirteen edition. In one aspect, the filtercake comprises a bridging agent. Bridging agents are selected from calcium carbonate, silica flour, fibers, insoluble metal salts, insoluble metal oxides, insoluble metal hyroxides and mixtures thereof. The fibers are often selected from insoluble polysaccharides.

The dehydrating agent mentioned above preferably has a water activity measurement of below 0.6. Preferably, the dehydrating agent is selected from concentrated inorganic salt solutions, concentrated organic salt solutions, acid anhydrides, esters, alcohols, ethers, ketones, aldehydes, amides, organic acids and mixtures thereof. Inorganic materials within the concentrated inorganic salt solutions comprise inorganic oxides and multivalent salts. In one aspect, the multivalent salts can comprise multivalent halides. The multivalent salts can also comprise salts of transitional metals or salts selected from calcium bromide, zinc bromide, calcium chloride, zinc chloride, aluminum chloride, aluminum bromide, aluminum bromide, manganese chloride, manganese bromide, ferric chloride, formates of sodium, potassium and cesium, and mixtures thereof.

In one preferred embodiment the organic salt solution comprises an inorganic solvent. In an alternative embodiment the organic salt solution comprises an organic solvent. In one embodiment, the organic solvent comprises an alcohol. In another embodiment the solvent comprises a ketone.

In a preferred embodiment, the inorganic salt solution can comprise an organic solvent. Alternatively, the inorganic salt solution comprises an inorganic solvent. In another embodiment the organic solvent comprises an alcohol. In yet another embodiment, the inorganic salt solvent comprises water as a solvent.

In one embodiment of the method, the acid anhydrides are selected from acetic anhydride and propionic anhydride and mixtures thereof. In another preferred embodiment the esters are selected from methyl formate, ethyl formate, methyl orthoformate, ethyl orthoformate and mixtures thereof. The esters can also comprise polyesters and/or cyclic esters.

Preferably, a mild acid is generated from the dehydrating agent. During this method, the water-dispersible polymeric material form a filtercake having bridging agents and the mild acid degrades the bridging agent thereby causing the filtercake to break apart.

In one method, a dehydrating agent is used to degrade a filtercake. The method comprises contacting the filtercake with the dehydrating agent until the filtercake is sufficiently degraded to be removed. The dehydrating agent is selected from concentrated inorganic salt solutions, concentrated organic salt solutions, acid anhydrides, esters, alcohols, ethers, ketones, aldehydes, amides organic acids and mixtures thereof. Preferably, the inorganic salts are selected from calcium bromide, zinc bromide, calcium chloride, zinc chloride, aluminum chloride, aluminum bromide, manganese chloride, manganese bromide, ferric chloride, formates of sodium, potassium and cesium, and mixtures thereof. The inorganic salt solution can comprise a water solvent. In another embodiment, the inorganic salt solution comprises an organic solvent. The organic salt solvent can comprise an alcohol. Preferably, a mild acid is generated from the dehydrating agent. In one embodiment the filtercake comprises water dispersible, polymeric material. The filtercake can further comprise non-polymeric bridging agents and the mild acid degrades this bridging agent.

In another preferred method, a dehydrating agent is used to degrade a downhole filtercake comprising bridging agents, the filtercake comprising water-dispersible polymeric material. The method comprises contacting the water-dispersible polymeric material of the filtercake with a dehydrating agent. The dehydrating agent is selected from concentrated inorganic salt solutions, concentrated organic salt solutions, acid anhydrides, esters, alcohols, ethers, ketones, aldehydes, amides, organic acids and mixtures thereof. Alcohols can include methanol, ethanol, polyols, glycols, polyglycols, and the like. The dehydrating agent is added until the filtercake is sufficiently degraded to be removed. It is preferred that the filtercake comprise water-soluble or water dispersible polymeric materials.

In an alternative method, a dehydrating agent is used to degrade downhole fluid loss pills. The method comprises contacting fluid loss pills with a dehydrating agent. The dehydrating agent is selected from concentrated inorganic salt solutions, concentrated organic salt solutions, acid anhydrides, esters, alcohols, ethers, ketones, aldehydes, amides, organic acids and mixtures thereof. The dehydrating agent is added until the fluid loss pills are sufficiently degraded to allow removal. The fluid loss pills can comprise water dispersible polymeric materials.

### DETAILED DESCRIPTION

Broadly, this invention relates to a method for the controlled degradation and de-functionalization of downhole polymers. As used in this description and the appended claims, the word de-functionalization means “to render non-functioning.”

The drilling of a wellbore often requires the temporary use of water-dispersible polymeric materials. Water-dispersible polymers are used in the makeup of filtercakes layered along the walls of a formation to prevent hydrocarbon leakage prior to the production stage. Water-dispersible polymers are also commonly used in fluid loss pills. Once these substances are no longer required, for example, when the well is ready to produce, the filtercake or fluid loss pills must be removed in a manner that is of least damage to the bore hole and the production formation. Removal of the deposited filtercake or fluid loss pills should be as complete as possible to increase flow in or out of the formation.

To accomplish removal of the deposited filtercake or fluid loss pills in accordance with the present method, a dehydrating agent is used to degrade the downhole, water-dispersible, polymeric material after it is no longer useful in the well. One benefit of this method is that it renders the water-dispersible polymeric material non-functional without many of the ill effects of prior methods, such as premature leaking of fluids into the well bore. Contacting the filtercake or other downhole composition with a dehydrating agent degrades the filtercake by removing water molecules from the water dispersible polymeric structure. The removal of the water molecules results in a physical change that affects the functionality and performance of the filtercake polymers. The physical state of the polymers is changed to discrete particulates or powders so that the filtercake breaks apart and can be washed away, thereby rendering the polymers non-functional.

The detailed description of this invention will be limited to the embodiment encompassing the degradation of a filtercake and fluid loss pills. However, the method works just as efficiently to degrade other downhole materials comprised of water dispersible polymers. In the method as described, filtercake formed on the walls of a subterranean borehole is removed by contacting the filtercake with a dehydrating agent for a period of time required to break down the filtercake so that production fluids flow. Filtercakes are typically formed with polymers that encapsulate particles or solids known as bridging agents which form a bridge over the pores of the formation.

The water-dispersible polymers that form filtercakes or fluid loss pills can be either natural, semi-synthetic or synthetic polymers. Many forms of water-dispersible polymers are known. The natural water soluble and dispersible polymers typically comprise polysaccharides, for example complex carbohydrates of the sugar group. Included but not limited to this group are such polysaccharides as xanthan, hydroxy celluloses, guar gum, and welan gum and mixtures thereof. Synthetic natural polymers or semi-synthetic polymers are chemically treated natural polymers such as cellulose ethers, including carboxymethylcellulose, methylcellulose and various kinds of modified starches including ethers and acetates. Synthetic polymers include acrylic polymers, for example, polyacrylamides and polyacrylates. Additionally, the polymer for the filtercake can be selected from starch or starch derivatives, cellulose derivatives and biopolymers such as hydroxypropyl starch, hydroxyethyl starch, carboxymethyl starch and their corresponding crosslinked derivatives; carboxymethyl cellulose, hydroxyethyl cellulose, hydroxypropyl cellulose, methyl cellulose, dihydroxypropyl cellulose, and their corresponding crosslinked derivatives; xanthan gum, gellan gum, welan and the like.

Bridging agents within the drill-in fluid may be composed of water soluble, acid soluble or oil soluble materials. The filtercake comprises solid bridging agents. Solid bridging agents include calcium carbonate, silica flour, fibers, insoluble metal salts, insoluble metal oxides, insoluble metal hydroxides and mixtures thereof. If fibers are used, they are selected from insoluble polymers. Additional examples of the materials used for bridging agents include sized salt solids in salt saturated solutions, finely ground carbonates found in limestone, marble, or dolomite, insoluble carbonates of metals, metal oxides, metal hydroxides or oil soluble material such as resins, waxes and the like.

Once the filtercake is no longer required, typically prior to the operation stage of an oil or gas well, the filtercake is removed from the walls of the producing formation. To that effect, a dehydrating agent is sent down hole with compatible completion fluids for contact with the filtercake until it is sufficiently degraded by dehydration of the polymer to be removed. The dehydrating fluids are selected for their characteristic of attracting water molecules from other compounds or mixtures. One indication or measurement of the dehydrating capacity of an agent used in this invention is its water activity measurement. Since filtercakes are tough, almost insoluble coatings, the dehydrating capacity of the agent must be effective enough so as to attract the water molecules within the polymer thereby causing the polymer to break up and disperse. In one aspect of this invention, the dehydrating agent may be selected from concentrated inorganic salt solutions, concentrated organic salt solutions, acid anhydrides, esters, alcohols, ethers, ketones, aldehydes, amides, organic acids and mixtures thereof. Other dehydrating agents, known in the art, can also be used, including various forms of foam-forming materials. The dehydrating capacity of these agents can be measured by its water activity.

Water activity of dehydrating agent solutions is a measurement of the “free water” as determined by water vapor or humidity above the solution. Because dehydrating agents bind water molecules, there is very little “free” water available. For example, many metal ions in brines have an affinity for water and bind water molecules. As a result, there is less “free water” available and the “water activity” decreases as the concentration of metal ions increases. The water activity is easily measured by an electrohygrometer which simply measures the amount of water in the vapor above the fluid. The water activity of the agent solutions is therefore a measurement of the “free water” as determined by the water vapor or humidity above the solution. An effective dehydrating agent for the degradation of a filtercake or fluid loss pill has a water activity measurement of below 0.6.

As a generality, the greater the charge on the metal ion, the higher the affinity for water and the higher the number of water molecules that will be bound to the metal. This means that divalent ions, such as calcium or zinc will bind water more strongly than monovalent ions such as sodium or potassium. As a consequence these solutions also have an affinity to attract water from their surroundings. The comparison between measured dehydrating agents must be made on a equimolar basis, not weight basis. Based on experimental data, activities for several concentrated brines are given in the Table below:

TABLE
Water Activities for Miscellaneous Brine Fluids

| Brine | Activity |
|---|---|
| 9.7 ppg NaCl | 0.81 |
| 10.0 ppg NaCl | 0.77 |
| 9.1 ppg CaCl₂ | 0.98 |
| 11.6 ppg CaCl₂ | 0.40 |
| 10.0 ppg CaBr₂ | 0.89 |
| 14.2 ppg CaBr₂ | 0.34 |
| 16.2 ppg ZnBr₂ | 0.33 |
| 19.2 ppg ZnBr₂ | 0.22 |

Certain generalizations can be based on water activity. Based on molar equivalent basis it has been determined that:
a. Activity decreases with increasing brine concentration
b. Activity is less with smaller ions (given equal concentrations)
c Activity is less with divalent ions than with monovalent ions

Dehydrating agents are chosen for their water activity level as well as compatibility with other downhole chemicals. A wide range of dehydrating agents is available and includes the following: concentrated inorganic salt solutions, concentrated organic salt solutions, acid anhydrides, esters, alcohols, ethers, ketones, aldehydes, amides, organic acids and mixtures thereof.

Inorganic salts, when used as a dehydrating agent within a concentrated inorganic salt solution, can comprise multivalent salts. The multivalent salts can include multivalent halides and salts of transitional metals. Preferably, salts are selected from calcium bromide, zinc bromide, calcium chloride, zinc chloride, aluminum chloride, aluminum bromide, manganese chloride, zinc chloride, aluminum chloride, aluminum bromide, manganese chloride, manganese bromide, ferric chloride, formates of sodium, potassium and cesium, and mixtures thereof.

The organic salt solution used for practicing the method of this invention can comprise an organic solvent, such as alcohols, esters or acetone; or an inorganic solvent, water for example. The inorganic salt solution used as a dehydrating agent can also comprise either organic solvents, alcohols for example, or inorganic solvents, water being the most common, or mixtures thereof.

When acid anhydrides are used as the dehydrating agent, they are selected from acetic anhydride, propionic anhydride, or any other anhydride known in the art, and mixtures thereof. Dehydrating agents made from esters include methyl formate, ethyl formate, methyl orthoformate, ethyl orthoformate as well as polyesters and cyclic esters. Alcohols can include methanol, ethanol, polyols, glycols, polyglycols, and the like.

The water-dispersible polymeric material comprising a filtercake (or fluid loss material) typically have bridging agents which form the wall of the filtercake. As the dehydrating agent removes the water molecule from the water-dispersible polymer, the polymer becomes ineffective and transformed into discrete particulates within the completion fluid that can be flushed out of the well bore. Some water soluble or water dispersible bridging agents will also be affected by the dehydrating agent and break apart. This occurs when the water molecules associated with the polymer molecules are attracted to the dehydrating agent. At that point, the polymer molecules are no longer strongly associated with the bridging agent. In some embodiments of this invention, especially useful for filtercakes having acid soluble, water-insoluble bridging agents, the selected dehydrating agent generates a mild to weak acid that can attack and disperse or dissolve the bridging agent. Acids are referred to as strong or weak according to the concentration of the H⁺ ion that results from ionization. Lewis, Richard J., Sr., Hawley's Condensed Chemical Dictionary, thirteen edition, p. 14.

Applicant defines a mild acid as one having a H⁺ ion concentration that is less than 10⁻² M. These bridging agents are degraded by the mild acid generated during the dehydration of the polymers. For example, if the known bridging agent is calcium carbonate and the dehydrating agent is acetic anhydride, the acid generated that degrades the bridging agent is acetic acid.

As in many industrial processes, the drilling of oil and gas wells results in contaminated by-products. Any downhole fluids such as brine that can be recycled are often preferred. The method of this invention facilitates the reclamation of contaminated downhole fluids. In one embodiment of this invention, rendering the water-dispersible polymers non-functional leaves the polymers as discrete particulates that are more easily separated from the brines than dissolved or dispersed polymers thereby allowing the brine to be reused.

In an alternative method for the controlled degradation of water-dispersible polymers, the polymers are used in the formulation of downhole fluid loss pills. The fluid loss pills are contacted with a dehydrating agent that is mixed with a drilling or completion fluid. As the dehydrating agent contacts the fluid loss pills, water molecules are attracted to the dehydrating agent causing the break up of the fluid loss pills. In one aspect of this invention, the dehydrating agent is selected from concentrated inorganic salt solutions, concentrated organic salt solutions, acid anhydrides, esters, alcohols, ethers, ketones, aldehydes, amides, organic acids and mixtures thereof. Other dehydrating agents known in the art can also be used, including various forms of foam-forming materials. The dehydrating agent is added downhole until the fluid loss pills are sufficiently degraded to be removed.

The method of this invention is considered a controlled treatment of downhole polymers that results in making the polymers that make up the filtercake, fluid loss pills or other temporary downhole products non-functional. It is controlled because, unlike prior methods, the de-functionalization of the polymers is a slow process. Because the process is controlled, the breakdown of the filtercake wall lining the production cavity is relatively uniform so that the formation wall is restored to its natural permeability to allow for hydrocarbon production.

### TEST EXAMPLES

### EXAMPLES

The following examples illustrate the performance of some dehydration additives that can be used in the degradation/defunctionalization of hydrated polymers with different water based fluids at relatively low temperature. The Tables also illustrate the range of dehydration rates of filter cakes containing hydrated polymers using the methodology of the invention. The break time is the time in which the filter cake is sufficiently degraded such that the measured fluid loss is dramatically, almost exponentially, increased. In these examples, the break time is a reflection of rate of the defunctionalization of the polymer. A rapid or shorter break time indicates that the dehydrating agent is more effective in breaking up the polymers by removing the water molecule from water-dispersible polymers and therefore more effective in the defunctionalization of the filtercake. The break time can be controlled by varying the concentration of the additive as well as the combination of additive used during the procedure. In a laboratory, break time can also be controlled by varying the temperature. As used in the oil field a controlled defunctionalization of downhole polymers is accomplished by selection of the dehydrating agents and concentration of agents used in the breaker fluids. The controlled defunctionalization allows the filtercake to be removed at a slower and more uniform pace thereby avoiding spot breakthroughs of the filtercake lining the walls which results in premature spurts of formation fluid. The test examples reveal the principle of the invention as well as the importance of the conditions (concentration and identity of dehydrating agents, etc.) on its application and effectiveness. The results of the test examples are illustrated in Table-2 below.

### Test Examples 1-3

These examples show the importance of the concentration of the organic dehydrating agent. In examples 1 & 2 with only 25 % of methanol or acetic anhydride at 1600 F, no facile break down of the cake is observed. However, with a mixture of the two (total concentration of 50 %, example 3), break down is relatively facile with a break time of 48 hrs.

### Test Example 4

In example 4, another dehydrating agent (ethyl orthoformate) is shown to be effective at the 25% level at the same temperature, illustrating the importance of the identity of the agent. Some agents can be more effective in certain instances than others. The orthoformate can act not only as a polymer defunctionalizer/dehydrator but concomitantly it can release an acid sufficient to degrade the calcium carbonate.

### Test Example 5

Example 5 illustrates the effectiveness of a temperature increase. Despite a reduction in the concentration of the organic defunctionalizing additives from 50% total to 30% total, the break time is reduced dramatically (from 48 hr to 4 hr). Although less dramatic, similar reductions in break time with an increase in temperature are observed for examples 6 & 7, and 8 & 9.

### Test Examples 6-11

The effective of concentration is most dramatically illustrated with these examples using 100% of the organic defunctionalizing agent. The importance of the balance of several factors is revealed by the slightly longer break times associated with the organic species that slowly liberate a mild acid in concert with the defunctionalization of the polymer (e.g., examples 8 & 9, or 10 versus examples 6 & 7). As mentioned above, the anticipated effect of temperature is illustrated by the examples 6-9 as well.

Table-1 below gives one of the drill-in fluid formulations containing the hydrated polymers. The fluid which is CaBr₂/NaBr based has a specific gravity (SG) of 1.618.

TABLE 1
Drill-In Fluid Containing Hydrated Polymers

| Component | Grams/Liter |
|---|---|
| CaBr₂ Brine (SG = 1.702) | 795.43 |
| NaBr Brine (SG = 1.498) | 704.00 |
| Cationic Starch | 13.70 |
| Sodium Thiosulfate | 0.71 |
| Magnesium Oxide | 2.86 |
| Xanthan Biopolymer | 3.42 |
| Sized Marble #1 (3 μm to 400 μm) | 42.86 |
| Sized Marble # 2 (1 μm to 36 μm) | 42.86 |
| Shale Stabilizer (Proprietary Glycol | 30.86 |
| Blend) | |

Drilling-in Fluid Composition:

The CaBr₂ and NaBr brines are a stock commercial product marketed by TETRA Technologies, Inc. The cationic starch used was also commercially Is available from TETRA Technologies, Inc. The sodium thiosulfate and magnesium oxide were USP grade. The xanthan biopolymer and cationic starch are commercially available from several suppliers. The sized marble powders are available from TETRA Technologies, Inc. under the trade names TETRA PayZone® Carb-Prime and TETRA PayZone® Carb-Ultra, respectively. The shale stabilizer (proprietary glycol blend) is available from TETRA Technologies, Inc. under the trade name StrataFix™.

Clean-Up Fluid:

The clean-up fluid for the tests below was a solution of the dehydration agent, which was used from 0 to 100% by vol. in a mixture of zinc bromide brine (SG=1.682 g/ml). Break time was controlled by varying the dehydrating agents, the concentration of agents and temperature as given in Table-2.

Experimental Procedures:

The following mixing procedure was followed for all drilling fluid preparations. The formulation was prepared by mixing the components in the order as written in the Table-1. After the starch was added, before addition of the next components, the mixture was sheared with a high-shear mixer (Silversen type) for 30 seconds. Then the mixing was continued at 500 RPM using a low-shear Servodyne unit for 30 minutes. This shearing process was intended to simulate commercial mixing with a high shear centrifugal pump. The remaining chemicals were added followed by 30 minutes of mixing. Total mixing time was 60 minutes.

Rheological Properties:

Rheological properties were measured at 120° F. After formulation of the fluid, the samples were “hot-rolled” at 160° F in a roller oven for 17 hours. After the ‘hot rolling’, the rheological properties were again measured at 120° F. The samples were then used for “filter cake preparation and removal”.

Filter Cake Preparation:

A filter cake was prepared using a standard high temperature and high pressure cell (HTHP cell) with a 5 μm (2000 mD permeability) ceramic disk as the filtering medium. Filter cake preparation was run at test temperature over 17 hours, with a squeeze pressure of 2100 KPa applied to the fluid. The filtrate was collected during this time and measured. A filter cake was produced that had an initial spurt fluid loss as the filter cake was building, but then had a rapid decline as the filter cake limited further fluid loss. At the end of the cake building time (17 hrs), the cell was cooled and the pressure released. The remaining fluid was drained from the cell and the filter cake was examined visually for uniformity.

Breaker Fluid (Containing Dehydrating Agent) Testing

To a uniform filter cake in the HPHT cell, a breaker fluid mixed with various dehydrating agents was added (The fluid specific gravity was adjusted to a 1.681 S.G. with CaBr₂/NaBr brine). The cell was then pressurized (usually 55 to 700 KPa); temperature was adjusted, and time was monitored. After the breaker fluid had broken through the filter cake, the final break time was recorded. Test data for various additives and temperatures are given in Table-2.

TABLE 2
Filter Cake Removal by Miscellaneous Dehydrating Agents

| | | Break | Temperature |
|---|---|---|---|
| Ex | Agent | Time | ° F. |
| 1 | ZnBr₂/25% Methanol | None | 160 |
| 2 | ZnBr₂/25% Acetic Anhydride | None | 160 |
| 3 | ZnBr₂/25% Methanol; 25% Acetic | 48 hours | 160 |
| | Anhydride | | |
| 4 | ZnBr₂/25% Ethyl Orthoformate | 90 hours | 160 |
| 5 | ZnBr₂/20% Acetic Anhydride; 10% | 4 hours | 200 |
| | Methanol | | |
| 6 | 100% Methanol | 70 minute | 140 |
| 7 | 100% Methanol | 40 minute | 200 |
| 8 | 100% Acetic Anhydride | 80 minute | 130 |
| 9 | 100% Acetic Anhydride | 54 minute | 200 |
| 10 | 100% Ethyl Orthoformate | 75 minute | 200 |
| 11 | 50% Acetic Anhydride; 50% Methanol | 95 minute | 200 |

The foregoing description is illustrative and explanatory of preferred embodiments of the invention, and variations in the size, shape, materials and other details will become apparent to those skilled in the art. It is intended that all such variations and modifications which fall within the scope or spirit of the appended claims be embraced thereby.

1. A method for the controlled de-functionalization of downhole polymers, the method comprising:
contacting downhole, water-dispersible, polymeric material with a dehydrating agent until the water-dispersible polymeric material is sufficiently degraded to be removed.

2. The method of claim 1 wherein the water-dispersible polymeric material is selected from natural water dispersible polymers, synthetic natural water dispersible polymers or synthetic water dispersible polymers.

3. The method of claim 1 wherein the water-dispersible polymeric material comprises fluid loss pills.

4. The method of claim 1 wherein the water-dispersible polymeric material comprises a filtercake.

5. The method of claim 4 wherein the water-dispersible polymeric material of the filtercake is selected from natural water dispersible polymers, synthetic natural water dispersible polymers or synthetic water dispersible polymers.

6. The method of claim 5 wherein the natural water dispersible polymers are polysaccharides.

7. The method of claim 6 wherein the polysaccharides comprise xanthan, hydroxy celluloses, guar gum, welan gum and mixtures thereof.

8. The method of claim 4 wherein the filtercake comprises solid bridging agents.

9. The method of claim 5 wherein the synthetic water dispersible polymers are selected from polyacrylamides, polyacrylates, or mixtures thereof.

10. The method of claim 4 wherein bridging agents are selected from calcium carbonate, other metal carbonates, silica flour, fibers, insoluble metal salts, insoluble metal oxides, insoluble metal hydroxides and mixtures thereof.

11. The method of claim 10 wherein the fibers are insoluble polysaccharides.

12. The method of claim 1 wherein the dehydrating agent has a water activity measurement of below 0.6.

13. The method of claim 1 wherein the dehydrating agent comprises concentrated inorganic salt solutions, concentrated organic salt solutions, inorganic oxides, inorganic metal oxides, acid anhydrides, esters, alcohols comprising methanol, ethanol, polyols, glycols,and polyglycols, ethers, ketones, aldehydes, amides, organic acids and mixtures thereof.

14. The method of claim 13 wherein the inorganic salts within the concentrated inorganic salt solutions comprise multivalent salts.

15. The method of claim 14 wherein the multivalent salts comprise multivalent halides.

16. The method of claim 14 wherein the multivalent salts comprise salts of transitional metals.

17. The method of claim 14 wherein the multivalent salts comprise salts selected from calcium bromide, zinc bromide, calcium chloride, zinc chloride, aluminum chloride, aluminum bromide, manganese chloride, manganese bromide, ferric chloride, formates of sodium, potassium and cesium, and mixtures thereof.

18. The method of claim 13 wherein the organic salt solution comprises an inorganic solvent.

19. The method of claim 13 wherein the organic salt solution comprises an organic solvent.

20. The method of claim 13 wherein the inorganic salt solution comprises an organic solvent.

21. The method of claim 13 wherein the inorganic salt solution comprises an inorganic solvent.

22. The method of claim 13 wherein the organic salt solution comprises an alcohol solvent.

23. The method of claim 13 wherein the inorganic salt solution comprises an alcohol solvent.

24. The method of claim 13 wherein the inorganic salt solution comprises a ketone solvent.

25. The method of claim 13 wherein the inorganic salt solution comprises a ester solvent.

26. The method of claim 13 wherein the inorganic salt solution comprises a water solvent.

27. The method of claim 13 wherein the organic salt solution comprises an ketone solvent.

28. The method of claim 13 wherein the organic salt solution comprises an ester solvent.

29. The method of claim 13 wherein the acid anhydrides are selected from acetic anhydride and propionic anhydride and mixtures thereof.

30. The method of claim 13 wherein the esters are selected from methyl formate, ethyl formate, methyl orthoformate, ethyl orthoformate and mixtures thereof.

31. The method of claim 13 wherein the esters are polyesters.

32. The method of claim 13 wherein the esters are cyclic esters.

33. The method of claim 1 wherein a mild acid is generated from the dehydrating agent.

34. The method of claim 33 wherein the water-dispersible polymeric material comprises a filtercake having bridging agents and the mild acid degrades the bridging agent.

35. A method for the controlled degradation of a filtercake comprising:
contacting the filtercake with a dehydrating agent until the filtercake is sufficiently degraded to be removed.

36. The method of claim 35 wherein the dehydrating agent is selected from concentrated inorganic salt solutions, concentrated organic salt solutions, acid anhydrides, esters, alcohols comprising methanol, ethanol, polyols, glycols, polyglycols, ethers, ketones, aldehydes, amides, organic acids and mixtures thereof.

37. The method of claim 36 wherein the inorganic salts within the concentrated inorganic salt solutions comprise salts selected from calcium bromide, zinc bromide, calcium chloride, zinc chloride, aluminum chloride, aluminum bromide, manganese chloride, manganese bromide, ferric chloride, formates of sodium, potassium and cesium, and mixtures thereof.

38. The method of claim 36 wherein the inorganic salt solution comprises a water solvent.

39. The method of claim 36 wherein the inorganic salt solution comprises an organic solvent.

40. The method of claim 39 wherein the organic solvent is an alcohol.

41. The method of claim 34 wherein the filtercake comprises water-dispersible, polymeric material.

42. The method of claim 34 wherein a mild acid is generated from the dehydrating agent.

43. The method of claim 42 wherein the filtercake further comprises non-polymeric bridging agents and the mild acid degrades the bridging agent.

44. A method for the controlled degradation of a downhole filtercake comprising bridging agents, the method comprising:
Contacting a downhole filtercake comprised of water-dispersible polymeric material with a dehydrating agent, the dehydrating agent selected from concentrated inorganic salt solutions, concentrated organic salt solutions, acid anhydrides, esters, alcohols, ethers, ketones, aldehydes, amides, organic acids and mixtures thereof;
adding the dehydrating agent until the filtercake is sufficiently degraded to be removed.

45. The method of claim 44 wherein a mild acid is generated and the non-polymeric bridging agents are degraded by the mild acid.

46. A method for the controlled degradation of downhole fluid loss pills comprising:
contacting fluid loss pills with a dehydrating agent, the dehydrating agent selected from concentrated inorganic salt solutions, concentrated organic salt solutions, acid anhydrides, esters, alcohols, ethers, ketones, aldehydes, amides, organic acids and mixtures thereof;
adding the dehydrating agent until the fluid loss pills are sufficiently degraded to be removed.

47. The method of claim 46 wherein the fluid loss pills comprises water-dispersible polymeric materials.
